(19) United States
(12) Patent Application Publication
(10) Pub. No.: US 2017/0064008 A1
(43) Pub. Date: Mar. 2, 2017

(54) NETWORK EQUIPMENT AND NON-TRANSITORY COMPUTER READABLE STORAGE MEDIUM

(71) Applicant: KYOCERA Document Solutions Inc., Osaka (JP)

(72) Inventor: Keiji SAKABE, Osaka (JP)

(73) Assignee: KYOCERA Document Solutions Inc., Osaka (JP)

(21) Appl. No.: 15/253,549

(22) Filed: Aug. 31, 2016

(30) Foreign Application Priority Data
Aug. 31, 2015 (JP) 2015-170928

(51) Int. Cl. H04L 29/08

(52) U.S. Cl. CPC H04L 67/143; H04L 67/104

(57) ABSTRACT

Provided is a network equipment that improves security via a P2P connection. The network equipment includes a network control part and a system control part. The network control part controls a first communication mode performing communication with a user terminal via a wired LAN network, a second communication mode performing communication with a portable terminal via a wireless LAN network and a third communication mode performing communication not via the wired LAN network and the wireless LAN network. When connection is established via the third communication mode, if the wired LAN network and/or the wireless LAN network are/is not in connection, the system control part causes the network control part to perform direct communication after the communication via the wired LAN network and the wireless LAN network are sopped, and to further restrict a request via the direct communication.

### INCORPORATION BY REFERENCE

This application is based on and claims the benefit of priority from Japanese Patent Application No. 2015-170928 filed on Aug. 31, 2015, the entire contents of that are hereby incorporated by reference.

### BACKGROUND

The present disclosure relates to a network equipment that is connected to a wired LAN network and a wireless LAN network.

In a typical image forming apparatus such as MFP (Multifunction Peripheral) including a multifunction printer and a multifunction machine, it is configured to be able to connect to a user terminal such as a PC (Personal Computer) and to a portable terminal such as a smartphone via a wired LAN (Local Area Network) network and a wireless LAN network.

Further, some of models of the image forming apparatus, it is designed to be able to perform data reception such as printing data and wireless communication which performs an instruction data reception such as a printing instruction via a P2P (Peer to peer) connection with a portable terminal, not via an access point. Note that a Wi-Fi direct (registered trademark) is generally used as the P2P connection.

As an image forming apparatus compatible with such P2P connection, it has been proposed so far, as atypical technology, a technology which is capable of automatically switching, at a timing according to an operation state of the image forming apparatus per se between a wireless communication via a P2P connection or a wireless communication via an access point.

Namely, a communication device (printing device) controls communication with an external device, in communication mode either of a first wireless communication mode (or wired communication mode) or a second wireless communication mode. When an operation state of the communication device (printing device) transits to an other state such as a power saving state, or the like, if a communication mode is set to the second wireless communication mode, the communication device (printing device) switches the communication mode to the first wireless communication mode (or wired communication mode).

### SUMMARY

According to one aspect of the present disclosure, the present disclosure provides A network equipment includes a memory that stores a control program and a processor that executes the control program. When the processor executes the control program, the processor operates to control a first communication mode performing communication with a user terminal via a wired LAN network, a second communication mode performing communication with a portable terminal via a wireless LAN network, and a third communication mode performing direct communication with the portable terminal not via the wired LAN network and the wireless LAN network. And when the processor executes the control program, when connection is established via the third communication mode, if the wired LAN network and/or the wireless LAN network are/is not in connection, the processor operates to perform the direct communication after the communication via the wired LAN network and the wireless LAN network is stopped, and restrict a request via the direct communication.

According to another aspect of the present disclosure, the present disclosure provides a non-transitory computer readable storage medium stores a control program executable by a computer of a network equipment. The control program causes the computer to execute controlling a first communication mode performing communication with a user terminal via a wired LAN network, a second communication mode performing communication with a portable terminal via a wireless LAN network, and a third communication mode performing direct communication with the portable terminal not via the wired LAN network and the wireless LAN network. And when connection is established via the third communication mode, if the wired LAN network and/or the wireless LAN network are/is not in connection, the control program causes the computer to perform the direct communication after the communication is stopped via the wired LAN network and the wireless LAN communication, and restricting a request via the direct communication.

### BRIEF DESCRIPTION OF THE DRAWINGS

FIG. 1 shows an overview of a connection mode to a MFP according to one embodiment in a case where a network equipment of the present disclosure if applied to the MFP;

FIG. 2 shows an internal configuration of the MFP shown in FIG. 1; and

FIG. 3 shows steps of function restriction processing in the MFP shown in FIG. 2.

### DETAILED DESCRIPTION

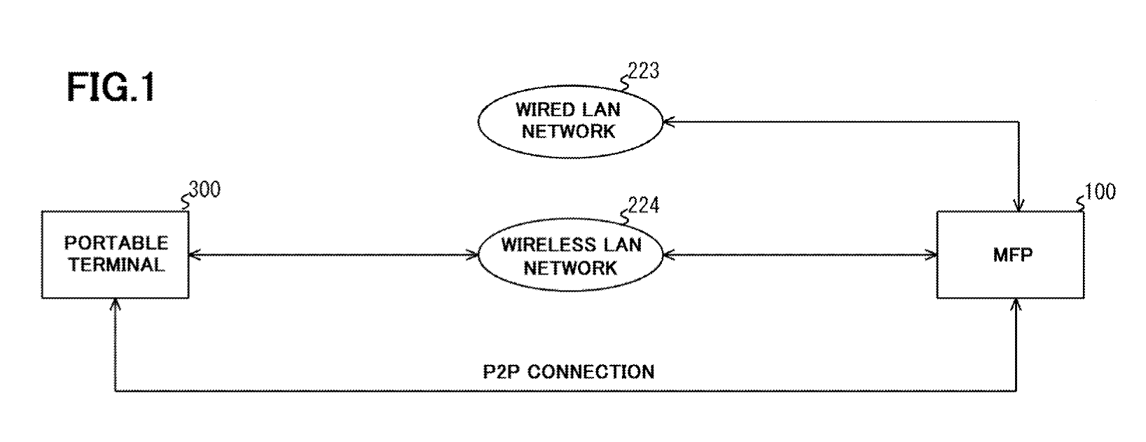

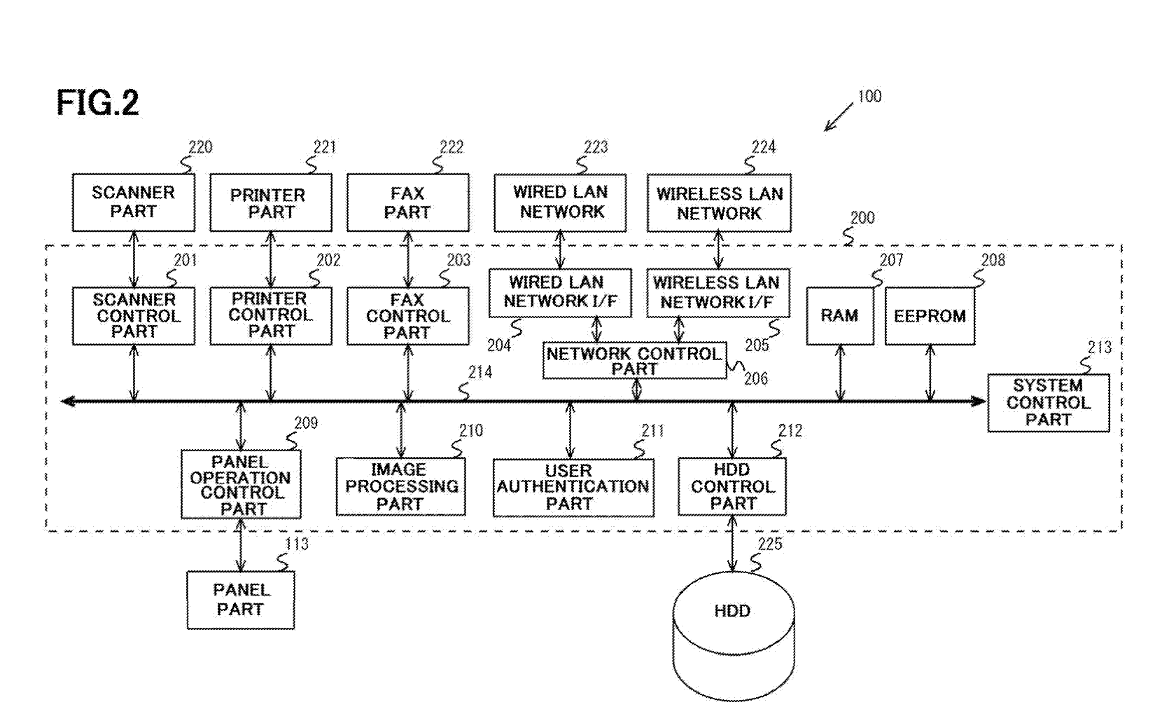

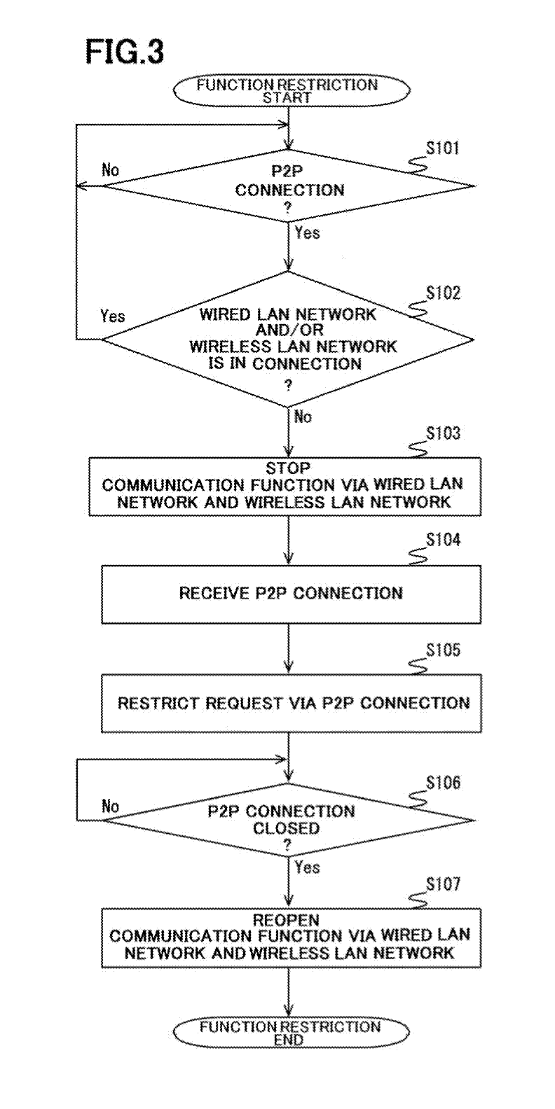

Hereinafter, a detailed description will be given to one embodiment of the present disclosure with reference to FIGS. 1-3. As one example of a network equipment in the following description, it is assumed to be a MFP (Multifunction Peripheral) that is a complex peripheral equipment in which, for example, a printing function, a copying function, a FAX function, a data transmitting and receiving function via a network, a wireless communication function that allows a P2P (peer to peer) connection with a portable terminal, and a user box function are installed. Note that a Wi-Fi direct (registered trademark) is commonly used as the P2P connection.

A description will be given first to an overview of a connection mode to the MFP with reference to FIG. 1. The MFP 100 is configured to be able to connect to a user terminal such as a PC (personal Computer) via a wired LAN (Local Area Network) network 223. Further, the MFP 100 is configured to be able to connect to a portable terminal 300 such as a smartphone via a wireless LAN network 224. Moreover, the MFP 100 is configured to be able to connect to the portable terminal 300 such as a smartphone.

Next, a description will be given to one example of an internal configuration of the MFP 100. The MFP 10 includes a control part 200, a scanner part 220, a printer part 221, a FAX part 222, a panel part 113 and a HDD 225.

The scanner part 220 is a device that converts an image signal of a document to be read by an image sensor into digital image data, and inputs to the control part 200.

The printer part 221 is a device that prints an image on a paper based on the image data output from the control part 200. The FAX part 222 is a device that transmits the image data output from the control part 200 to a destination facsimile via a telephone line, and receives the image data from the destination facsimile to input to the control part 200.

The panel part 113 is a device that performs selection from one of a printing function, a copying function, a FAX function, a data transmitting and receiving function via a network, a wireless communication function that allows a P2P connection with a portable terminal, and a user box function, displays for various settings, and receives a selection instruction and instruction for the various settings.

The HDD 225 is a device that stores an application program to provide various functions of the MFP 100. The HDD 225 has a plurality of partitions. The plurality of partitions is divided into partitions for an OS (Operating System), an installed application program, image data handling, and a user box that stores a user file.

The control part 200 is a processor that controls the whole operation of the MFP 100 by executing an image forming program and the other control program. The control part 200 includes a scanner control part 201, a printer control part 202, a FAX (Facsimile) control part 203, a wired LAN network I/F (interface) 204, a wireless LAN network I/F (interface) 205, a network control part 206, a RAM (Random Access Memory) 207, an EEPROM (Electrically Erasable Programmable Read-Only Memory) 208, a panel operation control part 209, an image processing part 210, an user authentication part 211, a HDD control part 212, and a system control part 213. These parts are connected to a data bus 214.

The scanner control part 201 controls a reading operation of the scanner part 220. The printer part 202 controls a printing operation of the printer part 221. The FAX control part 203 controls a transmitting and receiving operation of image data by the FAX part 222.

The network control part 206 performs transmission and reception control of data via the wired LAN network 223 and the wireless LAN network 224 through the wired LAN network I/F 204 and the wireless LAN network I/F 205. In this connection, the wireless LAN network 224 is formed via a Wi-Fi (registered trademark) rooter that is an access point. Further, the network control part 206 controls wireless communication by a P2P connection with a portable terminal. In the P2P connection, the network control part 206 forms a wireless network with the portable terminal 300, not via the Wi-Fi(registered trademark) rooter, with the own device (MFP 100) as an access point, via the wireless LAN network I/F 205. Further, the network control part 206 manages an access point of the Wi-Fi (registered trademark) rooter. Furthermore, the network control part 206 performs a setting and change of a name of the access point following an instruction of a user.

The RAM 207 is a work memory to execute a program. A control program to perform an operation check of each part is stored in the EEPROM 208. Also, log information about an operation executed by an application program is stored in the EEPROM 208.

The panel operation control part 209 controls a display operation of the panel part 113. The image processing part 210 performs image processing (rasterization) to image data. The user authentication part 211 performs user authentication by receiving user information such as an ID (Identification) and a password when receiving a setting and change instruction from the panel control part 113. Further, when access is received from a user terminal and a portable terminal, the user authentication part 211 receives the user information such as the user ID and the password and performs user authentication.

The HDD control part 212 controls reading and writing of data from and to the HDD 225. The system control part 213 controls a cooperative operation of each part. Further, the system control part 213 performs control based on a selection of one of a printing function, a copying function, a FAX function, a data transmitting and receiving function via a network, and a user box function of the MFP 100 from a user through the panel part 113. Note that the printing function, the copying function, the FAX function, the data transmitting and receiving function via the network, and the user box function of the MFP 100 can be made using a portable terminal.

Further, when receiving wireless communication from the portable terminal via the P2P connection, the system control part 213 stops a transmission and reception of data via the wired LAN network 206 and the wireless LAN network 223 through the network control part 206. Moreover, when receiving wireless communication from the portable terminal via the P2P connection, the system control part 213 restricts a request from the portable terminal.

That is, the system control part 213 restricts reading of a file stored in the user box of the MFP 100. This prevents leakage of confidential information stored in the user box of the MFP 100. The system control part 213 restricts a request for a setting and change of the MFP 100. This prevents the settings of the MFP 100 from freely rewritten without permission. Moreover, the system control part 213 allows reception of printing data from the portable terminal, but does not allow a printing instruction. In this case, the system control part 213 allows only a printing instruction from the panel part 113. Since this restricts a printing instruction of a large amount of printed matter, the system control part 213 prevents the MFP 100 from being temporarily unavailable.

A description will then be given to function restrictions at the MFP 100 side.

### (Step S101)

First, the system control part 213 determines whether or not a P2P connection is established from a portable terminal. In this instance, the system control part 213 waits for notification that the P2P connection is established from the network control part 206 (step S101: No). If notification is received that the P2P connection is established from the network control part 206, the system control part 213 makes determination that the P2P connection is established from the portable terminal (step S101:Yes).

### (Step S102)

The system control part 213 determines whether or not the wired LAN network 223 and/or the wireless LAN network 224 are/is in connection. In this case, if the system control part 213 receives notification that the wired LAN network 223 and/or the wireless LAN network 224 are/is in connection from the network control part 206 (step S102:Yes), the system control part 213 waits until the wired LAN network 223 and/or the wireless LAN network 224 and/is closed. Then, if the system control part 213 receives notification that the wired LAN network 223 and/or the wireless LAN network 224 and/is not in connection, the system control part 213 determines that the wired LAN network 223 and/or the wireless LAN network 224 and/is closed (step S102: No).

### (Step S103)

The system control part 213 stops a communication function via the wired LAN network 223 and the wireless LAN network 224 through the network control part 206.

### (Step S104)

The system control part 213 receives a P2P connection from a portable terminal through the network control part 206.

### (Step S105)

The system control part 213 restricts a request via the P2P connection from the portable terminal. That is, as stated above, the system control part 213 restricts reading of a file stored in the user box of the MFP 100. This prevents leakage of confidential information stored in the user box of the MFP 100. Further, as stated above, the system control part 213 restricts a request for a setting and change of the MFP 100. This prevents the settings of the MFP 100 from being freely rewritten without permission. Moreover, as stated above, the system control part 213 allows reception of print data from the portable terminal, but does not allow a print instruction. In this case, the system control part 213 only allows a print instruction from the panel part 113. Since this restricts a printing instruction for an unexpected large amount of printed matter, it prevents a situation where the MFP 100 becomes temporally unavailable.

### (Step S106)

The system control part 213 determines whether or not a P2P connection with a portable terminal is closed. In this case, the system control part 213 waits for a termination of the P2P connection from the network control part 206(step S106: No). Then, if the system control part 213 receives closing of termination of the P2P connection from the network control part 206, the system control part 213 determines that the P2P connection with the portable terminal is closed (step S106:Yes).

The system control part 213 reopens a communication function via the wired LAN network 223 and the wireless LAN network 224 through the network control part 206.

Thus, in the present embodiment, the network control part 206 controls the data transmission and reception function (first communication mode) performing communication with the user terminal through the wired LAN network 223, the data transmission and reception function (second communication mode) performing communication with the portable terminal via the wired LAN network 224, and the P2P connection (third communication mode performing direct communication) with the portable terminal not via the wired LAN network 223 and the wireless LAN network 224. Further, when the P2P connection is established, if the wired LAN network 223 and/or the wireless LAN network 224 are/is not in connection, the system control part 213 causes the network control part 206 to stop communication via the wired LAN network 223 and the wireless LAN network 224. After that, the system control part 213 performs the P2P connection and further restricts a request via the P2P connection.

This prevents at least leakage of confidential information via the P2P connection with the portable terminal, thereby improving security via the P2P connection.

More specifically, since the system control part 213 restricts a reading request for a file via the P2P connection, it prevents leakage of confidential information stored in the user box of the MFP 100. Further, since the system control part 213 restricts a request for a setting and change of the MFP 100, it prevents the settings of the MFP 100 from freely rewritten without permission. Furthermore, since the system control part 213 allows reception of print data from the portable terminal, but does not allow a printing instruction, and only allows a printing instruction from the panel part 113, it restricts a printing instruction of an unexpected large amount of printed matter thereby preventing the MFP 100 from being temporally becoming unavailable.

Moreover, if the wired LAN network 223 and the wireless LAN network 224 are in connection, the system control part 213 causes the network control part 206 to stop communication via the wired LAN network 223 and the wireless LAN network 224 after the wired LAN network 223 and/or the wireless LAN connection 224 and/is closed. Therefore, even if a request via the P2P connection with the portable terminal is restricted, an adverse effect is not exerted on the data transmission and reception function via the wired LAN network 223 and the wireless LAN network 224.

The P2P connection between the image forming apparatus and the portable terminal enables access to the image forming apparatus as far as the communication covers a range within which a radio wave can reach. Because there is a possibility that the image forming apparatus may hold various information containing confidential information, it needs to pay enough attention to information leakage. Also, if the settings of the image forming apparatus were to be freely rewritten without permission or a printing instruction for an unexpected large amount of printed matter were to be given, there would be a case, in some cases, where the image forming apparatus becomes temporally unavailable.

Given such situation, in an environment where the wired LAN network, the wireless LAN network and the P2P connection are simultaneously utilized, it has been longing for the development of a network equipment which enables improvement of security via the P2P connection.

According to the present disclosure, the disclosure prevents at least leakage of confidential information, thereby improving security via direct communication.

It should be noted that in the present embodiment, a description is given to a case where the network equipment is applied to the MFP 100. However, not necessarily limited thereto, the present disclosure can be applied to an equipment which is able to use the wired LAN network 223, the wireless LAN network 224 and the P2P connection, and holds confidential information, or the like.

What is claimed is:

1. A network equipment comprising:
a memory that stores a control program; and
a processor that executes the control program,
wherein when the processor executes the control program, the processor operates to:
control a first communication mode performing communication with a user terminal via a wired LAN network, a second communication mode performing communication with a portable terminal via a wireless LAN network, and a third communication mode performing direct communication with the portable terminal not via the wired LAN network and the wireless LAN network, and
when connection is established via the third communication mode, if the wired LAN network and/or the wireless LAN network are/is not in connection,
perform the direct communication after the communication via the wired LAN network and the wireless LAN network is stopped, and
restrict a request via the direct communication.

2. The network equipment according to claim 1, wherein when the processor performs the control program, if the wired LAN network and/or the wireless LAN network are/is in connection, the processor operates to stop the communication via the wired LAN network and the wireless LAN network after the connection is established via the wired LAN network and/or the wireless LAN network are/is closed.

3. The network equipment according to claim 1, wherein when the processor performs the control program, the processor operates to restrict a request for reading of a file, a setting and change, and a printing instruction via the direct communication.

4. The network equipment according to claim 3, further comprising a panel that accepts the printing instruction, and wherein when the processor performs the control program, the processor operates to allow only the printing instruction from the panel.

5. A non-transitory computer readable storage medium storing a control program executable by a computer of a network equipment for causing the computer to execute:
controlling a first communication mode performing communication with a user terminal via a wired LAN network, a second communication mode performing communication with a portable terminal via a wireless LAN network, and a third communication mode performing direct communication with the portable terminal not via the wired LAN network and the wireless LAN network, and
when connection is established via the third communication mode, if the wired LAN network and/or the wireless LAN network are/is not in connection,
performing the direct communication after the communication is stopped via the wired LAN network and the wireless LAN communication, and
restricting a request via the direct communication.

6. The non-transitory computer readable storage medium according to claim 5, wherein if the wired LAN network and/or the wireless LAN network are/is in connection, further causing the computer to execute stopping the communication via the wired LAN network and the wireless LAN network after the wired LAN network and/or the wireless LAN network are/is closed.

7. The non-transitory computer readable storage medium according to claim 5, further causing the computer to execute restricting a request for reading of a file, a setting and change, and a printing instruction via the direct communication.

8. The non-transitory computer readable storage medium according to claim 7, further causing the computer to execute allowing only the printing instruction from a panel that accepts the printing instruction.
